(19) United States
(12) Patent Application Publication
(10) Pub. No.: US 2022/0161453 A1
(43) Pub. Date: May 26, 2022

(54) ULTRASONIC CUTTER AND ULTRASONIC CUTTER COOLING AND CHIP DIVERSION SYSTEM

(71) Applicant: INDUSTRIAL TECHNOLOGY RESEARCH INSTITUTE, Hsinchu (TW)

(72) Inventors: YAN-SIN LIAO, Taichung (TW); YU-SHIANG HUANG, Taichung (TW); YUNG-CHAO CHAN, Taichung (TW); SHIH-CHIEH LO,, Yuanlin City (TW); SZU-CHIA LIN, Yilan City (TW); CHIU-HUNG LI, Taichung (TW)

(21) Appl. No.: 17/202,649

(22) Filed: Mar. 16, 2021

(30) Foreign Application Priority Data
Nov. 20, 2020 (TW) 109140653

(51) Int. Cl. B26D 7/08; B26D 7/18

(52) U.S. Cl. CPC B26D 7/086; B26D 7/088; B26D 7/1863

(57) ABSTRACT

An ultrasonic cutter includes a tool holder and an ultrasonic oscillator. The tool holder has a lower circular air-out aisle defined by sleeving an inner ring and an outer ring. The inner ring has oppositely a first surface and a second surface, and the outer ring has oppositely a third surface and a fourth surface. A gap spacing the first surface from the third surface has an upper air inlet and a lower air outlet. The second surface has a lower inner inclined surface forming a first angle with the first surface. The fourth surface has an outer inclined surface forming a second angle with the third surface. The ultrasonic oscillator, disposed in a chamber of the tool holder spatially connected with the gap, is used for providing ultrasonic oscillation to a cutter. In addition, a cooling and chip diversion system for the ultrasonic cutter is also provided.

### CROSS REFERENCE TO RELATED APPLICATION

This application claims the benefits of Taiwan application Serial No. 109140653, filed on Nov. 20, 2020, the disclosures of which are incorporated by references herein in its entirety.

### TECHNICAL FIELD

The present disclosure relates in general to a technology of machine tools, and more particularly to an ultrasonic cutter and a cooling and chip diversion system for the ultrasonic cutter.

### BACKGROUND

Based on excellent processing performances of composite materials and hard and brittle materials, a demand for ultrasonic processing has been born.

For instance, the glass fiber reinforced polymer (GFRP) is one of major structural materials in the market for aviation, wind energy, shipping, transportation, construction and other technical industries. Due to excellent material properties, a reduced weight and comprehensive economic characteristics, the GFRP is widely applied to the aviation and automobile industries.

In the art, an ultrasonic cutter and an ultrasonic oscillator are usually adopted to process the composite materials. However, the current challenge is that, in considering pollution of waste materials, processing of the composite materials can not be cooled by a liquid-state cutting fluid. Thus, heat generated by the ultrasonic oscillator itself and/or accumulated during the processing is hard to dissipate. As a result, the processing precision would be reduced, and also the operational ultrasonic frequency would be drifted. In addition, the processing of the composite materials would produce dust or powders, which will definitely risk people's life and also shorten the service life of the machine.

Conventionally, cooling water or a cold compressed air is usually introduced via conduits or cavity housing to cool down the heat source such as an ultrasonic oscillator, and to dissipate the heat out of the ultrasonic cutter. Regarding the dust and the powders, a pressurized air is utilized to form an air wall to stop the flying chips. However, the aforesaid methods can only provide limited cooling and chip-removing capacities. Thereupon, the heat of the ultrasonic oscillator and the cutter can't be effectively dissipated, and the dust can't be well collected. Thus, in order to resolve the aforesaid difficulties, the resulted machinery would occupy more space, and be more complicate structured.

Accordingly, an issue how to develop a simply structured ultrasonic cutter and a cooling and chip diversion system for the ultrasonic cutter that can effectively cool down the ultrasonic cutter and remove chips thereof is definitely urgent to be resolved for the skill in the art.

### SUMMARY

In one embodiment of this disclosure, an ultrasonic cutter includes a tool holder and an ultrasonic oscillator. The tool holder is furnished with a circular air-out aisle at a lower portion thereof. The circular air-out aisle is formed by an inner ring and an outer ring sleeving the inner ring. The inner ring having a first surface and a second surface opposite to the first surface, and the outer ring having a third surface and a fourth surface opposite to the third surface. The first surface is spaced from the third surface by a gap, and the gap has an upper air inlet and a lower air outlet. The second surface has an inner inclined surface at a lower portion thereof, and a first angle is formed between the inner inclined surface and the first surface. The fourth surface has an outer inclined surface, and a second angle is formed between the outer inclined surface and the third surface. The ultrasonic oscillator, disposed in a chamber of the tool holder, is used for providing ultrasonic oscillation to a cutter, in which the chamber and the gap are spatially connected.

In another embodiment of this disclosure, a cooling and chip diversion system for the ultrasonic cutter includes a compressed-air generator, a dust collector and a vacuum device. The compressed-air generator is used for providing a compressed air to the ultrasonic cutter. The dust collector, surrounding and shielding the ultrasonic cutter, has a bottom opening. The vacuum device, connected spatially with an interior of the dust collector, is to provide a suction force to drive the compressed air to pass through the chamber, to enter the circular air-out aisle via the air inlet, to leave the tool holder via the air outlet, and to be discharged via the dust collector.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the ultrasonic cutter mounted disposed to a spindle of a machine tool in accordance with this disclosure;

FIG. 2 is a schematic enlarged view of area A of FIG. 1;

FIG. 3 demonstrates schematically an embodiment of the cooling and chip diversion system for the ultrasonic cutter of FIG. 1 in accordance with this disclosure; and

FIG. 4 shows schematically flowing of the compressed air in the cooling and chip diversion system for the ultrasonic cutter of FIG. 3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

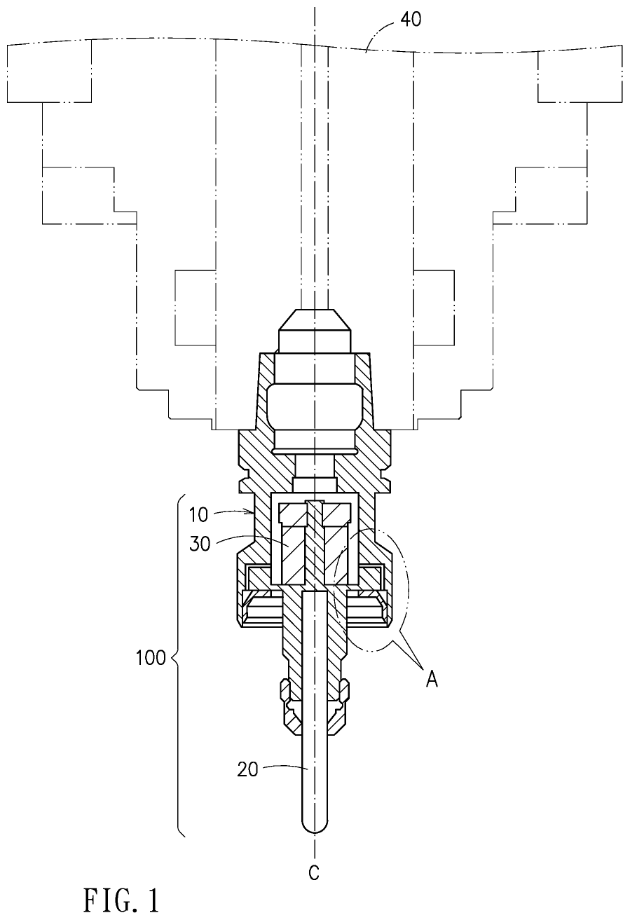

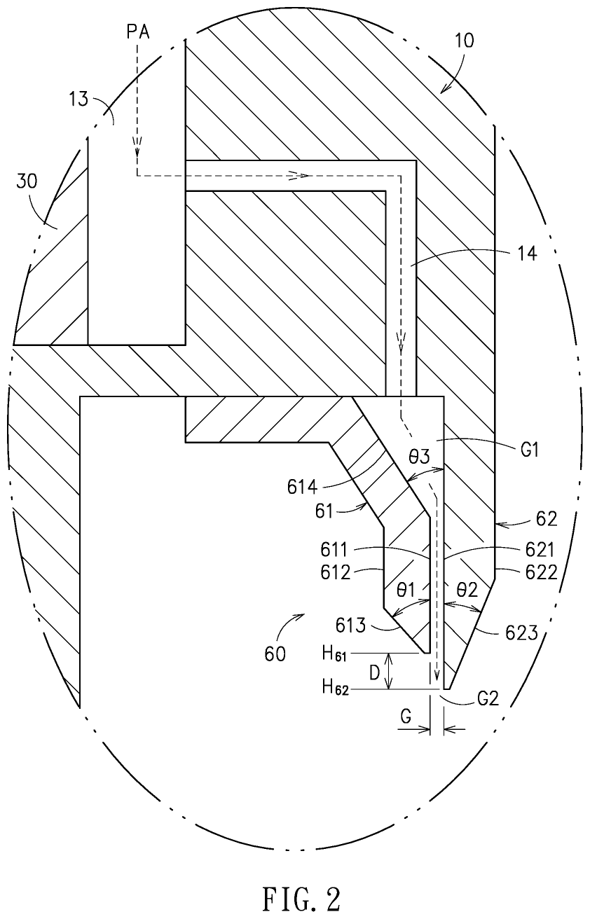

Referring to FIG. 1 and FIG. 2, an ultrasonic cutter 100 provided by this disclosure includes a tool holder 10 and an ultrasonic oscillator 30, in which a cutter 20 is provided to a lower portion of the tool holder 10.

The tool holder 10, relevant to be mounted to a spindle 40 of a machine tool, has the lower potion furnished with a circular air-out aisle 60. In this disclosure, the circular air-out aisle 60 can be shaped into any circular shape such as an annular ring.

The circular air-out aisle 60 is defined by an inner ring 61 and an outer ring 62 exterior to the inner ring 61, in a sleeving manner. The inner ring 61 has a first surface 611 and a second surface 612 opposite to the first surface 611. The outer ring 62 has a third surface 621 and a fourth surface 622 opposite to the third surface 621. The first surface 611 is parallel to the third surface 621 by a gap G. The gap G has an upper end defined as an air inlet G1 and a lower end defined as an air outlet G2. In addition, the gap G is larger than 0 mm, and equal to or smaller than 1.2 mm.

A lower portion of the second surface 612 is an inner inclined surface 613, and a first angle θ1 is formed between the inner inclined surface 613 and the first surface 611. A lower portion of the fourth surface 622 is an outer inclined surface 623, and a second angle θ2 is formed between the outer inclined surface 623 and the third surface 621. Each of the first angle θ1 and the second angle θ2 is larger than 0°, and equal to or smaller than 45°. In addition, the first angle θ1 is greater than or equal to the second angle θ2.

An upper portion of the first surface 611 is an upper inclined surface 614, and a third angle θ3 is formed between the upper inclined surface 614 and the third surface 621. The third angle θ3 is larger than or equal to 0°, and equal to or smaller than 45°, such that a funnel-shaped air inlet G1 can be formed to an upper portion of the gap G.

The lowest end of the inner ring 61 has a level height H61 equal to or higher than another level height H62 of the lowest end of the outer ring 62. Namely, the outer ring 62 is extended downward (i.e., in the longitudinal direction L) and lower than or flush with the inner ring 61. In this embodiment, the lowest end of the inner ring 61 having the level height H61 is spaced from the lowest end of the outer ring 62 having the level height H62 by a difference D. That is, the two level heights of the respective lowest ends is different by a distance equal to D. In this disclosure, the difference D can be, but not limited to, equal to or smaller than 5 mm.

The cutter 20, disposed to the lower portion of the tool holder 10, has an axis direction C parallel to the first surface 611 and the third surface 621. Generally speaking, the tool holder 10, the cutter 20, the ultrasonic oscillator 30 and the spindle 40 are coaxially disposed. The cutter 20 is used for processing a workpiece (not shown in the figure). The type of the cutter 20 is determined by the workpiece to be processed, and the workpiece can be made of a composite or brittle such as the GFRP.

The ultrasonic oscillator 30 is disposed in a chamber 13 of the tool holder 10 at a location above the cutter 20, and is used for providing ultrasonic oscillation to the cutter 20. The chamber 13 and the gap G are spatially connected via a channel 14. The channel 14 can be any type of spatial connection between the chamber 13 and the gap G.

After entering the chamber 13, a compressed air PA can be led to the circular air-out aisle 60 via the channel 14, and then flows out of the tool holder 10, as a dashed path shown in FIG. 2.

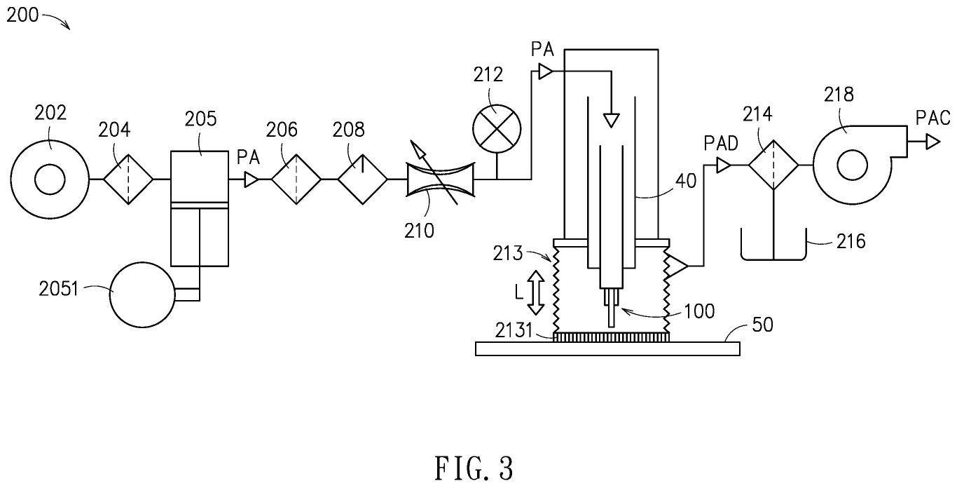

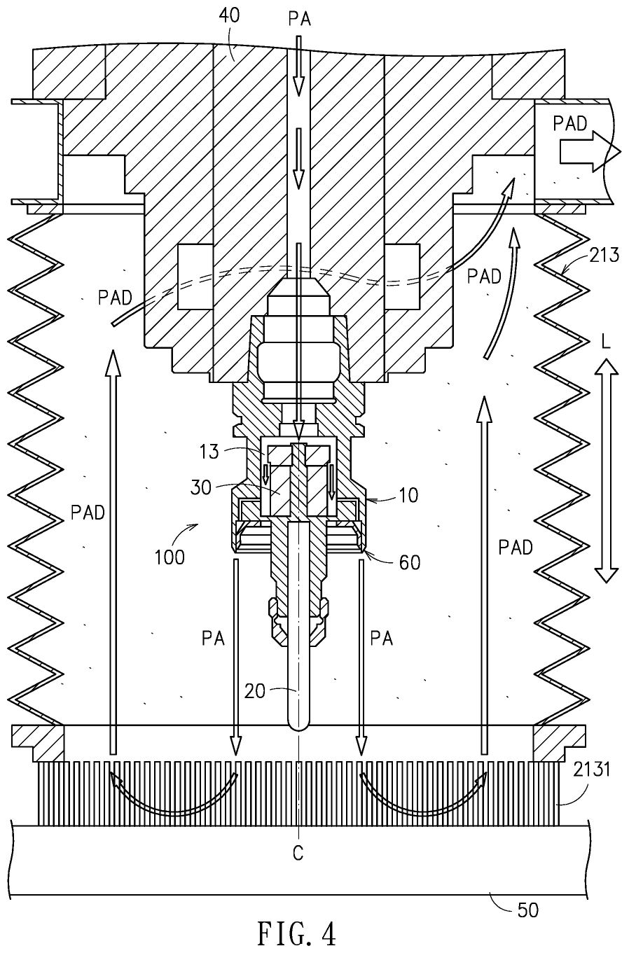

Referring to FIG. 3 and FIG. 4, a cooling and chip diversion system for an ultrasonic cutter 200 provided by this disclosure includes the ultrasonic cutter 100, a compressed-air generator 205, a dust collector 213 and a vacuum device 218.

The compressed-air generator 205 is used for supplying the compressed air PA.

The dust collector 213 to surround and shield the ultrasonic cutter 100 has a bottom opening. A longitudinal direction L of the dust collector 213 is parallel to the axis direction C of the cutter 20, and the dust collector 213 is scalable in the axis direction C. In this embodiment, the dust collector 213 is constructed into, but not limited to, a continuous corrugated structure such as a lantern. A brush 2131 for contacting a top of the workpiece 50 is provided to a lower edge of the dust collector 213.

The vacuum device 218, communicating spatially with an interior of the dust collector 213, is to provide a suction force.

In FIG. 3, the cooling and chip diversion system for an ultrasonic cutter 200 further includes an air supplier 202, a first filter 204, a second filter 206, an oil injector 208, a pressure adjuster 210, a pressure meter 212 and a dust filter 214.

The air supplier 202 provides an air to the first filter 204 for a preliminary filtration upon the air. Then, the air enters the compressed-air generator 205.

The compressed-air generator 205, driven by a motor 2051, is to generate the compressed air PA. The compressed air PA orderly passes the second filter 206, the oil injector 208, the pressure adjuster 210 and the pressure meter 212, and then the compressed air PA with a demanding pressure and satisfied cleanliness would be forwarded to the ultrasonic cutter 100.

Referring to FIG. 4, the compressed air PA firstly enters the spindle 40, and then flows into the tool holder 10 of the ultrasonic cutter 100. After the compressed air PA enters the tool holder 10, the compressed air PA would carry away the heat of the ultrasonic oscillator 30 while passing through the chamber 13. Thereupon, the ultrasonic oscillator 30 can be cooled down, and thus the phenomenon of ultrasonic frequency drift can be avoided.

Then, as shown in FIG. 2 and FIG. 4, the compressed air PA from the channel 14 enters the circular air-out aisle 60 via the air inlet G1, and the leaves the tool holder 10 via the air outlet G2. Since the tool holder 10 is furnished with the special circular air-out aisle 60, thus, while the compressed air PA flows out of the circular air-out aisle 60, a strong air flow would be formed to cool down the cutter 20, as shown in FIG. 4.

It shall be explained that, since the circular air-out aisle 60 is a circular channel, a circular air curtain of the compressed air PA would be formed to surround the axis direction C as well as the cutter 20 would be formed, while the compressed air PA flows out of the circular air-out aisle 60. In FIG. 4, two outflows of the compressed air PA out of a bottom of the tool holder 10 are only for an explanation purpose only, and practically the number of the outflows of the compressed sir PA might be larger than 2.

As shown in FIG. 4, after flowing out of the tool holder 10, the compressed air PA would collide firstly with the workpiece 50 and then be turned to flow upward to further mix the processing dust for forming the compressed air containing processing dust PAD inside the dust collector 213. By having the brush 2131 at the lower edge of the dust collector 213 to contact the top of the workpiece 50, the processing dust would be surrounded by the dust collector 213, and leakage of the compressed air PA, PAD would be substantially reduced.

Then, by providing the vacuum device 218 of FIG. 3, a suction force can be generated to vacuum the compressed air containing processing dust PAD out of the dust collector 213. As shown in FIG. 3, after the compressed air containing processing dust PAD enters the dust filter 214, dust would be filtered out and then sent into the dust collector 216. Then, the vacuum device 218 would discharge the clean compressed air PAC with the processing dust being filtered out.

In summary, the ultrasonic cutter and the cooling and chip diversion system for the ultrasonic cutter provided by this disclosure introduce the compressed air to pass through the ultrasonic-cutter oscillator chamber, and thus the heat of the ultrasonic oscillator would be carried away by the compressed air so as directly to cool down the ultrasonic oscillator. Further, since the ultrasonic cutter is specifically designed to have the circular air-out aisle, thus a limited amount of the compressed air is able to form a laminar air flow. While the surrounding air is inhaled, an air flow much stronger than the inhaled air flow would be formed. Empirically, the resulted air flow may be 40 times stronger than the inhaled flow. Hence, by applying this resulted air flow to cool down the cutter, a recycle rate of the dust can be substantially increased. In addition, with the circular air curtain in the dust collector to stop the splash of the processing dust, the modified dust-collecting opening can further increase the recycle rate of the dust. Thereupon, the ultrasonic oscillator and the cutter of this disclosure can be simply structured but to provide better performance. Thus, the aforesaid shortcomings such as failure to effectively dissipate the heat and collect the dust of processing composite-material chips can be better resolved.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An ultrasonic cutter, mounted to a spindle of a machine tool, comprising:
a tool holder, furnished with a circular air-out aisle at a lower portion thereof, the circular air-out aisle being formed by an inner ring and an outer ring sleeving the inner ring, the inner ring having a first surface and a second surface opposite to the first surface, the outer ring having a third surface and a fourth surface opposite to the third surface, the first surface being spaced from the third surface by a gap, the gap having an upper air inlet and a lower air outlet, the second surface having an inner inclined surface at a lower portion thereof, a first angle being formed between the inner inclined surface and the first surface, the fourth surface having an outer inclined surface, a second angle being formed between the outer inclined surface and the third surface; and
an ultrasonic oscillator, disposed in a chamber of the tool holder, used for providing ultrasonic oscillation to a cutter, the chamber and the gap being spatially connected.

2. The ultrasonic cutter of claim 1, wherein the first angle is greater than or equal to the second angle.

3. The ultrasonic cutter of claim 1, wherein the first surface has an upper inclined surface, a third angle is formed between the upper inclined surface and the third surface, and the third angle is greater than or equal to 0⁰, and equal to or less than 45°.

4. The ultrasonic cutter of claim 1, wherein a difference in level height exists between the lowest end of the inner ring and that of the outer ring.

5. The ultrasonic cutter of claim 1, wherein the outer ring is extended downward to be lower than or equal to the inner ring.

6. A cooling and chip diversion system for the ultrasonic cutter of claim 1, comprising:
a compressed-air generator, used for providing a compressed air to the ultrasonic cutter;
a dust collector, surrounding and shielding the ultrasonic cutter, having a bottom opening; and
a vacuum device, connected spatially with an interior of the dust collector, being to provide a suction force to drive the compressed air to pass through the chamber, to enter the circular air-out aisle via the air inlet, to leave the tool holder via the air outlet, and to be discharged via the dust collector.

7. The cooling and chip diversion system of claim 6, wherein a lower edge of the dust collector is furnished with a brush.

8. The cooling and chip diversion system of claim 6, wherein the dust collector has a continuous corrugated structure, a longitudinal direction of the dust collector is parallel to an axis direction of the cutter, and the dust collector is scalable.

9. The cooling and chip diversion system of claim 6, wherein the first angle is greater than or equal to the second angle.

10. The cooling and chip diversion system of claim 6, wherein the first surface has an upper inclined surface, a third angle is formed between the upper inclined surface and the third surface, and the third angle is greater than or equal to 0°, and equal to or less than 45°.

11. The cooling and chip diversion system of claim 6, wherein a difference in level height exists between the lowest end of the inner ring and that of the outer ring.

12. The cooling and chip diversion system of claim 6, wherein the outer ring is extended downward to be lower than or equal to the inner ring.
